(19) United States
(12) Patent Application Publication
(10) Pub. No.: US 2015/0188129 A1
(43) Pub. Date: Jul. 2, 2015

(54) SULFUR CATHODE OF LITHIUM SULFUR BATTERIES AND METHOD OF MANUFACTURING THE SAME

(71) Applicant: Hyundai Motor Company, Seoul (KR)

(72) Inventors: Sang Jin Park, Bucheon (KR); Hee Yeon Ryu, Yongin (KR)

(21) Appl. No.: 14/493,759

(22) Filed: Sep. 23, 2014

(30) Foreign Application Priority Data
Dec. 27, 2013 (KR) 10-2013-0165869

(51) Int. Cl. H01M 4/38; H01M 10/052; H01M 4/62; H01M 4/04; H01M 4/1397

(52) U.S. Cl. CPC H01M 4/38; H01M 4/0402; H01M 4/1397; H01M 4/625; H01M 4/622; H01M 4/623; H01M 10/052

(57) ABSTRACT

The present invention provides a lithium sulfur battery with improved life characteristics and enhanced battery capacity. Particularly, a cathode for the lithium sulfur battery may include two types of binders which are different in solvents systems and adhesion types.

### CROSS-REFERENCE TO RELATED APPLICATION

This application claims under 35 U.S.C. §119(a) the benefit of Korean Patent Application No. 10-2013-0165869 filed Dec. 27, 2013, the entire contents of which are incorporated herein by reference.

### TECHNICAL FIELD

The present invention relates to a lithium sulfur battery with improved life characteristics and enhanced battery capacity. In particular, a sulfur cathode for the lithium sulfur battery may include two types of binders which are different in solvents and adhesion types.

### BACKGROUND

Typical lithium sulfur batteries have a theoretical energy density of 2,600 Wh/kg, which is greater than conventional lithium ion batteries having a theoretical energy density of about 570 Wh/kg and a current level of ˜120 Wh/kg. However, when the lithium sulfur batter is discharged, sulfur of a cathode may melt and leak into an electrolyte in a form of polysulfide (Li₂Sₓ), which may result in destroying the structure of the cathode, thereby deteriorating battery life. Thus, in order to develop the lithium sulfur batteries having such features, the function of a binder to maintain a conductive structure may be critical for battery capacity and battery life.

In the related arts, a binder composition has been reported for an electrode and the binder composition comprises at least one tetracarboxylic acid ester compound, at least one diamine compound and an organic solvent. Such composition may have high binding power and not inhibit the formation of a stable interface (SEI) at the surface of an active material.

Alternatively, a binder composition used for making an electrode for a lithium-ion secondary battery has been developed and the composition comprises polymer particles dispersed in an organic medium having a boiling point of 80-350° C. at normal pressure. The polymer particles comprise at least one kind of structural units selected from (a) structural units derived from a monoethylenically unsaturated carboxylic acid ester monomer, (b) structural units derived from a monoethylenically unsaturated carboxylic acid monomer, and (c) structural units derived from a conjugated diene monomer; have a ratio of (a)/[(b)+(c)] of 99/1-60/40 by weight; have a total content of (a), (b) plus (c) of at least 80 wt % based on the total structural units; and are substantially free from structural units of a monoethylenically aromatic hydrocarbon monomer.

In addition, an organic binder also has been developed and the organic binder may be composed of a polymer having a double bond (i.e., polyolefinic rubber having a double bond) and capable of being crosslinked through vulcanization. For example, the rubber include natural rubber and synthetic rubber, and the synthetic rubber is exemplified by styrene-butadiene copolymer, isobutylene-isoprene copolymer as butyl rubber, acrylonitrile-butadiene-rubber (NBR) rubber, ethylenepropylene diene terpolymer (EPDM) and the like.

Meanwhile, in other examples, a cathode composition of a lithium sulfur secondary battery comprising vinylidene fluoride-based polymer as a cathode binder has been provided. In particular, it teaches that as the vinylidene fluoride-based polymer, polyvinylidene fluoride, a copolymer of vinylidene fluoride and hexafluoropropylene and a copolymer of vinylidene fluoride and tetrafluoroethylene can be used, and the composition further comprises an organic material into which sulfur is incorporated and a conductive polymer blend.

However, the above described techniques may not be sufficient to provide a desired level of adhesion strength, charge/discharge efficiency, stability and continuity in a manufacturing process so as to satisfy physical properties of a battery requiring high efficiency and stability such as a car battery.

Therefore, the present invention has been made to provide a binder constituting a cathode of a lithium sulfur battery, which may be characterized in stable discharge electricity in a high-capacity lithium sulfur battery, and a successive manufacturing process thereof. Further, the binder in the present invention may provide high adhesion strength with a small amount, thereby increasing an energy density of the battery.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention may provide a technical solution to the above-described problems in the related art.

In one aspect, the present invention provides a cathode composition of a lithium sulfur secondary battery, which may comprise: sulfur, a conductive material, a non-aqueous planar contact binder and an aqueous point contact binder.

In certain embodiments, the sulfur may be a sulfur particle, and the conductive material may be a conductive particle. In particular, the planar contact may be made with the sulfur particles or the conductive material particles in a planar phase, and the point contact comprises or may be made with the sulfur particles or the conductive material particles in a point phase.

In an exemplary embodiment, the conductive material of the cathode composition may be, but not limited to, one or more selected from the group consisting of graphite, Super C, vapor grown carbon fibers, Ketjen black, Denka black, acetylene black, carbon black, carbon nanotube, multi-walled carbon nanotube, ordered mesoporous carbon and combinations thereof.

In an exemplary embodiment, the non-aqueous planar contact binder of the cathode composition may be, but not limited to, one or more selected from the group consisting of polyvinyl acetate, polyvinyl alcohol, polyethylene oxide, polyvinylpyrrolidone, polyvinyl ether, polymethyl methacrylate, polyvinylidene fluoride, polyhexafluoropropylene-polyvinylidene fluoride copolymer, polyethylacrylate, polytetrafluoroethylene, polyvinyl chloride, polyacrylonitrile, carboxymethylcellulose (CMC) and combinations thereof.

In an exemplary embodiment, the aqueous point contact binder of the cathode composition may be, but not limited to, one or more selected from the group consisting of polyvinylpyrrolidone, polytetrafluoroethylene, styrene butadiene rubber (SBR), carboxymethylcellulose and combinations thereof.

In an exemplary embodiment, the non-aqueous planar contact binder of the cathode composition may be closer to the sulfur particles than the aqueous point contact binder.

In san exemplary embodiment, the cathode composition may comprise: the sulfur in an amount of about 40 to 85 wt %, the conductive material in an amount of about 10 to 50 wt %, the non-aqueous planar contact binder in an amount of about 2 to 25 wt %, and the aqueous point contact binder in an amount of about 2 to 25 wt %, based on the total weight of the cathode composition.

In another aspect, the present invention provides a method for manufacturing a cathode of a lithium sulfur secondary battery, comprising:

preparing a primary slurry by mixing sulfur, a conductive material, a first solvent and a non-aqueous planar contact binder,

preparing a primary composite by drying the primary slurry and pulverizing the primary slurry,

preparing a secondary slurry by mixing the primary composite, the conductive material and a second solvent with an aqueous point contact binder, and

coating the secondary slurry on a cathode plate.

In an exemplary embodiment, the first solvent used may be, but not limited to, one or more selected from the group consisting of N-Methylpyrrolidone, acetonitrile, isopropyl ether, benzene, chloroform, n-hexane, methanol, acetone and toluene, and the non-aqueous planar contact binder is one or more selected from the group consisting of polyvinyl acetate, polyvinyl alcohol, polyethylene oxide, polyvinylpyrrolidone, polyvinyl ether, polymethyl methacrylate, polyvinylidene fluoride, polyhexafluoropropylene-polyvinylidene fluoride copolymer, polyethylacrylate, polytetrafluoroethylene, polyvinyl chloride, polyacrylonitrile, carboxymethylcellulose (CMC) and combinations thereof.

In an exemplary embodiment, the solvent used in the step (3) of the method may be, but not limited to, water, and the aqueous point contact binder is one or more selected from the group consisting of polyvinylpyrrolidone, polytetrafluoroethylene, styrene butadiene rubber (SBR), carboxymethylcellulose (CMC) and combinations thereof.

In an exemplary embodiment, the conductive material of the method may be, but not limited to, one or more selected from the group consisting of graphite, Super C, vapor grown carbon fibers, Ketjen black, Denka black, acetylene black, carbon black, carbon nanotube, multi-walled carbon nanotube, ordered mesoporous carbon and combinations thereof.

In an exemplary embodiment, the secondary slurry of the method may comprise: the sulfur in an amount of about 40 to 85 wt %, the conductive material in an amount of about 10 to 50 wt %, the non-aqueous planar contact binder in an amount of about 2 to 25 wt %, and the aqueous point contact binder in an amount of about 2 to 25 wt %, based on the total weight of the secondary slurry.

In an exemplary embodiment, the secondary slurry may be prepared by dispersing the primary composite using ultrasonic waves and mixing the primary composite with the conductive material, the second solvent and the aqueous point contact binder.

In an exemplary embodiment, the secondary slurry is coated on a cathode plate.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 illustrates schematically an exemplary binder which may make a non-aqueous planar contact among conventional cathode binders for a lithium sulfur battery;

FIG. 2 illustrates schematically a binder which may make an aqueous point contact among conventional cathode binders for a lithium sulfur battery;

FIG. 3 illustrates schematically an exemplary pattern (left) in which two types of binders according to an exemplary embodiment of the present invention may contact with a cathode active material of a lithium sulfur battery; and an exemplary pattern (right) in which two types of binders may make a point contact or a planar contact according to an exemplar embodiment of the present invention; and

FIG. 4 is an exemplary graph showing discharge curves of samples 1 and 2 described in Example according to an exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

In one aspect, the present invention provides a cathode composition of a lithium sulfur secondary battery, which may comprise: sulfur, a conductive material, a non-aqueous planar contact binder and an aqueous point contact binder.

In certain embodiments, the sulfur may be a sulfur particle, and the conductive material may be a conductive material particle. In particular, the planar contact may be made with the sulfur particles or the conductive material particles in a planar phase, and the point contact may be made with the sulfur particles or the conductive material particles in a point phase.

In one preferred aspect, a cathode composition of a lithium sulfur secondary battery is provided comprising: sulfur; a conductive material; a non-aqueous planar contact binder; and an aqueous point contact binder, wherein a planar contact is made with or comprises the sulfur or the conductive material in a planar phase, and a point contact is made with or comprises the sulfur or the conductive material in a point phase.In other aspect, the present invention provides a method for manufacturing a cathode of a lithium sulfur secondary battery, which may comprise:

preparing a primary slurry by mixing sulfur, a conductive material, a first solvent and a non-aqueous planar contact binder,

preparing a primary composite by drying the primary slurry and pulverizing the primary slurry,

preparing a secondary slurry by mixing the primary composite, the conductive material and a second solvent with an aqueous point contact binder, and

coating the secondary slurry on a cathode plate.

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

As used herein, the terms “lithium sulfur battery”, “lithium sulfur cell”, “cell”, “battery” and the like refer to a lithium sulfur secondary batter unless stated otherwise. In addition, as used herein, the term “PVdF” refers to polyvinylidene fluoride, and the term “SBR” refers to styrene butadiene rubber.

In general, the binder which constitutes a cathode of a lithium sulfur battery may be classified into two types, a non-aqueous planar contact binder and an aqueous point contact binder, based on a solvent used therein and the type of adhesion.

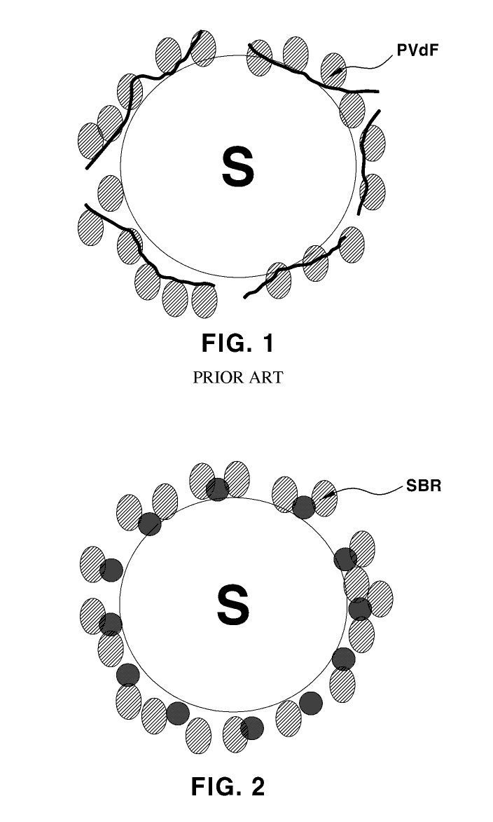

In FIG. 1, an exemplary non-aqueous planar contact binder is shown. The non-aqueous planar contact binder may have advantages. For example, the slurry may have improved dispersibility and stability in a non-aqueous solvent. In particular, since PVdF may have lithium ion conductivity when it is swollen in an electrolyte, the slurry may be easily mixed, thereby generating high voltage during the discharging. However, the use of the non-aqueous solvent may require high temperature and a long period of time for drying process, and a large amount of a binder may be used to maintain a certain level of adhesion, and thus an energy density of a cell may be reduced and a successive or continuous drying process may be difficult.

In FIG. 2, an exemplary aqueous point contact binder is shown. The aqueous point contact binder may also have advantages. For example, the aqueous point contact binder may be dried easily and may be applied to a successive or continuous manufacturing process of an electrode for a lithium sulfur battery, due to the low boiling point thereof. In addition, since a small amount of a binder may be used with high adhesion, an energy density of a cell may increase. However, the large particle size of the binder such as several tens of nanometers may cause generation of large electrochemical resistance; and because dispersion of a hydrophilic active material may be difficult, dispersibility and stability of the slurry may decrease, thereby reducing battery voltage due to the resistance inside the electrode during discharging.

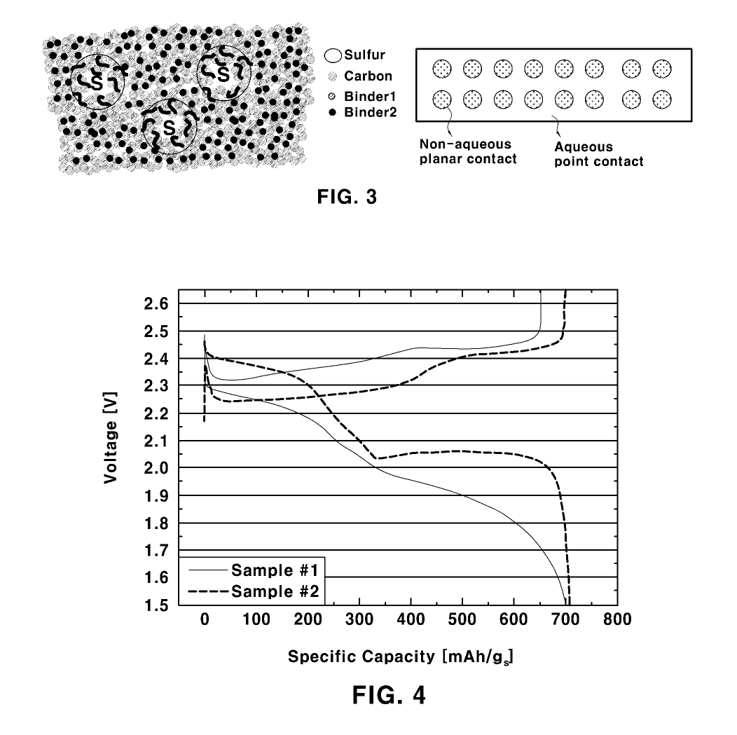

Accordingly, as illustrated in FIG. 3, the present invention provides a method using both types of binder, i.e. the non-aqueous planar contact binder and the aqueous point contact binder. The non-aqueous planar contact binder may be used at the portion adjacent to sulfur to confer high voltage during the discharging, and the aqueous point contact binder may be used at the other portion so as to confer high adhesion strength. In addition, due to the aqueous binder in the coating of an electrode, dry condition may be moderate and easy, thereby providing a cathode composition of a lithium sulfur secondary battery to which two types of binders may be applied for successive or continuous coatings.

In particular, the present invention provides a cathode composition of a lithium sulfur secondary battery, which may comprise: sulfur, a conductive material, a non-aqueous planar contact binder and an aqueous point contact binder. In certain embodiments, the sulfur may be a sulfur particle, and the conductive material may be a conductive material particle. Particularly, the planar contact comprises or may be made with the sulfur particle or the conductive material particle in a planar phase, and the point contact comprises or may be made with the sulfur particle or the conductive material particle in a point phase.

The conductive material may be selected from the group consisting of graphite, Super C (TIMCAL), vapor grown carbon fibers, Ketjen black, Denka black, acetylene black, carbon black, carbon manotubes, multi-walled carbon nanotubes, ordered mesoporous carbon, and combinations thereof, but is not limited thereto.

The non-aqueous planar contact binder may be selected from the group consisting of polyvinyl acetate, polyvinyl alcohol, polyethylene oxide, polyvinylpyrrolidone, polyvinyl ether, polymethyl methacrylate, polyvinylidene fluoride, polyhexafluoropropylene-polyvinylidene fluoride copolymer, polyethylacrylate, polytetrafluoroethylene, polyvinyl chloride, polyacrylonitrile, carboxymethylcellulose (CMC) and combinations thereof, or particularly, polyvinylpyrrolidone. For example, polyvinylpyrrolidone may be used as a non-aqueous planar contact binder, since it has substantially greater ion conductivity than other binders when it is swollen an electrolyte of the cell.

The aqueous point contact binder may be selected from the group consisting of polyvinylpyrrolidone, polytetrafluoroethylene, styrene butadiene rubber (SBR), and carboxymethylcellulose (CMC) and combinations thereof, or particularly, styrene butadiene rubber (SBR). For example, SBR may be used as an aqueous point contact binder, since it may have significantly high adhesion strength even in a small amount.

Meanwhile, the non-aqueous planar contact binder may exist closer to sulfur particles than the aqueous point contact binder, due to greater ion conductivity when the non-aqueous binder may be swollen in an electrolyte and an increase of discharge voltage.

In addition, the composition of the present invention may comprise the sulfur in an amount of about 40 to 85 wt %, the conductive material in an amount of about 10 to 50 wt %, the non-aqueous planar contact binder in an amount of about 2 to 25 wt %, and the aqueous point contact binder in an amount of about 2 to 25 wt %, based on the total weight of the cathode composition. Further, the composition of the present invention may be subjected to a successive coating process due to the moderate dry condition compared to that of a conventional binder. Simultaneously, electrochemical resistance may be decreased during charging and discharging, thereby generating a stable voltage curve of about 2.0 V or higher.

On the other hand, the present invention provides a method for manufacturing a cathode of a lithium sulfur secondary battery, which may comprise:

preparing a primary slurry by mixing sulfur, a conductive material, a first solvent and a non-aqueous planar contact binder,

preparing a primary composite by drying the primary slurry and pulverizing the primary slurry,

preparing a secondary slurry by mixing the primary composite, conductive material and solvent with an aqueous point contact binder, and

coating the secondary slurry on a cathode plate.

The first solvent may be, but not limited to, one or more selected from the group consisting of N-Methylpyrrolidone, acetonitrile, i-propyl ether, benzene, chloroform, n-hexane, methanol, acetone, and toluene, and the non-aqueous planar contact binder can be selected from the group consisting of polyvinyl acetate, polyvinyl alcohol, polyethylene oxide, polyvinylpyrrolidone, polyvinyl ether, polymethyl methacrylate, polyvinylidene fluoride, polyhexafluoropropylene-polyvinylidene fluoride copolymer, polyethylacrylate, polytetrafluoroethylene, polyvinyl chloride, polyacrylonitrile, carboxymethylcellulose (CMC), and combinations thereof.

The second solvent may be, but not limited to, water, and the aqueous point contact binder and may be selected from the group consisting of polyvinylpyrrolidone, polytetrafluoroethylene, styrene butadiene rubber (SBR), and carboxymethylcellulose (CMC), or particularly, styrene butadiene rubber (SBR).

Meanwhile, the conductive material may be selected from the group consisting of graphite, Super C (TIMCAL), vapor grown carbon fibers, Ketjen black, Denka black, acetylene black, carbon black, carbon manotubes, multi-walled carbon nanotubes, ordered mesoporous carbon and combinations thereof, but is not limited thereto.

In addition, the secondary slurry may comprise: the sulfur in an amount of about 40 to 85 wt %, the conductive material in an amount of about 10 to 50 wt %, the non-aqueous planar contact binder in an amount of about 2 to 25 wt %, and the aqueous point contact binder in an amount of about 2 to 25 wt %, based on the total weight of the secondary slurry composition.

On the other hand, the secondary slurry may be prepared by by dispersing the primary composite using ultrasonic waves and mixing the primary composite with the conductive material, the second solvent and the aqueous point contact binder. This step may provide an advantage in that the primary composite may be more uniformly dispersed in the aqueous solvent.

Particularly, in the manufacturing method of a cathode plate according to an exemplary embodiment of the present invention, coating the secondary slurry on a cathode plate may be successively or continuously performed. In other words, the manufacturing method may be successive or continuous without cessation. Typically, when a cathode for a lithium sulfur battery is manufactured, the cathode may be dried at a temperature of about 100° C. or below, due to a low melting point of sulfur, unlike the manufacturing of conventional lithium ion batteries. When the cathode for a lithium sulfur battery is produced in facilities for the conventional lithium ion batteries and NMP is used as a solvent, the NMP solvent may not be sufficiently dried due to such a low dry temperature, and thus the production facilities may be stopped to evaporate the solvent. To the contrary, when the aqueous binder is used according to exemplary embodiments of the present invention, drying and manufacturing of the cathode may be performed without such a step of stopping the production facilities.

### EXAMPLES

The following examples illustrate the invention and are not intended to limit the same.

Secondary slurries of samples 1 and 2 were prepared according to compositions described in Table 1 below. The method for preparing the secondary slurry was described as follows:

(1) preparing a primary slurry by mixing sulfur, a conductive material, a first solvent and a non-aqueous planar contact binder,

(2) preparing a primary composite by drying the primary slurry and pulverizing the primary slurry, and

(3) preparing a secondary slurry by mixing the primary composite, the conductive material and a second solvent with an aqueous point contact binder.

The sulfur used in the samples was in form of a particle.

TABLE 1

| | Sulfur | Conductive | Non-aqueous | |
|---|---|---|---|---|
| | Sulfur | material | planar | |
| | particle in a | VGCF | contact | Aqueous point |
| | size of 5 μm | (Vapor Grown | binder | contact binder |
| Sample # | or lower | Carbon fibers) | PVdF | SBR |
| 1 | 71 wt % | 23 wt % | 0 wt % | 6 wt % |
| 2 | 71 wt % | 23 wt % | 3 wt % | 3 wt % |

The first solvent for dissolving and dispersing the non-aqueous planar contact binder was NMP, and the second solvent for dissolving and dispersing the aqueous point contact binder was distilled water.

When the sample included only PVdF, NMP (N-Methylpyrrolidone) having a high boiling point as a solvent was used but required for dry condition of about 100° C. for about 30 min, which were not suitable for applying a successive coating process. Thus, this sample was excluded from the following experiment.

When the sample included only SBR (Sample #1), its dying condition was about 70° C. for 3 min, which makes it possible to apply a successive coating process. However, because of a large particle size of the binder, a significant amount of electrochemical resistance was generated during the charging/discharging of a battery.

When the sample include PVdF as a non-aqueous planar contact binder and SBR as an aqueous point contact binder, a successive coating process was applied due to the use of an aqueous solvent during the coating process, and simultaneously, the electrochemical resistance generated during the charging/discharging of a battery was decreased, to thereby show a stable voltage curve. In conclusion, the processability of an electrode coating was improved, and an energy density of a cell was increased.

The primary discharge curve for each sample is depicted in FIG. 4.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A cathode composition of a lithium sulfur secondary battery comprising:
a sulfur;
a conductive material;
a non-aqueous planar contact binder; and
an aqueous point contact binder,
wherein a planar contact is made with or comprises the sulfur or the conductive material in a planar phase, and a point contact is made with or comprises the sulfur or the conductive material in a point phase.

2. The cathode composition according to claim 1, wherein the sulfur is in a form of a particle.

3. The cathode composition according to claim 1, wherein the conductive material is one or more selected from the group consisting of graphite, Super C, vapor grown carbon fibers, Ketjen black, Denka black, acetylene black, carbon black, carbon nanotube, multi-walled carbon nanotube, ordered mesoporous carbon and combinations thereof.

4. The cathode composition according to claim 1, wherein the non-aqueous planar contact binder is one or more selected from the group consisting of polyvinyl acetate, polyvinyl alcohol, polyethylene oxide, polyvinylpyrrolidone, polyvinyl ether, polymethyl methacrylate, polyvinylidene fluoride, polyhexafluoropropylene-polyvinylidene fluoride copolymer, polyethylacrylate, polytetrafluoroethylene, polyvinyl chloride, polyacrylonitrile,carboxymethylcellulose (CMC) and combinations thereof.

5. The cathode composition according to claim 1, wherein the aqueous point contact binder is one or more selected from the group consisting of polyvinylpyrrolidone, polytetrafluoroethylene, styrene butadiene rubber (SBR), carboxymethylcellulose and combinations thereof.

6. The cathode composition according to claim 1, wherein the non-aqueous planar contact binder exists closer to the sulfur particles than the aqueous point contact binder.

7. The cathode composition according to claim 1, which comprises the sulfur in an amount of about 40 to 85 wt %, the conductive material in an amount of about 10 to 50 wt %, the non-aqueous planar contact binder in an amount of about 2 to 25 wt %, and the aqueous point contact binder in an amount of about 2 to 25 wt %, based on the total weight of the cathode composition.

8. A method for manufacturing a cathode of a lithium sulfur secondary battery, comprising:
preparing a primary slurry by mixing sulfur, a conductive material, a first solvent and a non-aqueous planar contact binder,
preparing a primary composite by drying the primary slurry and pulverizing the primary slurry,
preparing a secondary slurry by mixing the primary composite, the conductive material and a second solvent with an aqueous point contact binder, and
coating the secondary slurry on a cathode plate.

9. The method according to claim 8, wherein the first solvent is one or more selected from the group consisting of N-Methylpyrrolidone, acetonitrile, i-propyl ether, benzene, chloroform, n-hexane, methanol, acetone and toluene, and the non-aqueous planar contact binder is one or more selected from the group consisting of polyvinyl acetate, polyvinyl alcohol, polyethylene oxide, polyvinylpyrrolidone, polyvinyl ether, polymethyl methacrylate, polyvinylidene fluoride, polyhexafluoropropylene-polyvinylidene fluoride copolymer, polyethylacrylate, polytetrafluoroethylene, polyvinyl chloride, polyacrylonitrile, carboxymethylcellulose (CMC) and combinations thereof.

10. The method according to claim 8, wherein the solvent of the step (3) is water, and the aqueous point contact binder is one or more selected from the group consisting of polyvinylpyrrolidone, polytetrafluoroethylene, styrene butadiene rubber (SBR), carboxymethylcellulose (CMC), and combinations thereof.

11. The method according to claim 8, wherein the conductive material is one or more selected from the group consisting of graphite, Super C, vapor grown carbon fibers, Ketjen black, Denka black, acetylene black, carbon black, carbon nanotube, multi-walled carbon nanotube, ordered mesoporous carbon and combinations thereof.

12. The method according to claim 8, wherein the secondary slurry comprises the sulfur in an amount of about 40 to 85 wt %, the conductive material in an amount of about 10 to 50 wt %, the non-aqueous planar contact binder in an amount of about 2 to 25 wt %, and the aqueous point contact binder in an amount of about 2 to 25 wt % based on the total weight of the second slurry.

13. The method according to claim 8, wherein the secondary slurry is prepared by being dispersed the primary composite using ultrasonic waves and mixing it with the conductive material, the second solvent and the aqueous point contact binder.

14. The method according to claim 8, wherein the coating the secondary slurry on the cathode plate is successively performed.
